(19) United States
(12) Patent Application Publication
(10) Pub. No.: US 2023/0276976 A1
(43) Pub. Date: Sep. 7, 2023

(54) POUR-OVER COFFEE REPLICATION SYSTEM

(71) Applicant: HIROIA Communications Pte., Ltd., Singapore (SG)

(72) Inventors: Shuzo Matsumura, Singapore (SG); Takao Fujiki, Singapore (SG); Chyau Fuh Chang, Singapore (SG)

(21) Appl. No.: 17/676,552

(22) Filed: Feb. 21, 2022

(51) Int. Cl. A47J 31/10; A47J 31/44; A47J 31/40

(52) U.S. Cl. CPC A47J 31/10; A47J 31/402; A47J 31/4403

(57) ABSTRACT

The present invention provides a pour-over coffee replication system, comprising: an electronic scale, a thermometer, a mobile device, a cloud server and a coffee machine. During the process of making pour-over coffee, the electronic scale is used to obtain the weight time sequence of the coffee beans (powder) as well as the hot water, the thermometer is used to obtain the temperature time sequence of the output hot water. The mobile device integrates the data and converts all the data into a digital coffee making prescription, and uploads it to the cloud server for storage, so that one or more than one user can access from anywhere or at any time. After the coffee machine is connected to the cloud server, the digital coffee making prescription can be easily obtained, and the coffee machine can automatically replicate the process of making pour-over coffee and produce coffee having the same flavor and taste as pour-over coffee.

### BACKGROUND OF INVENTION

### 1. Field of the Invention

The present invention relates generally to a coffee making system, and more particularly to a pour-over coffee replication system.

### 2. Description of Related Art

There are lots of knowledge in connection with coffee, including varieties of coffee, means of processing, degrees of roast, and methods of brewing. Every aspect requires some techniques or know-hows, and will have direct influence on the flavor and taste of the coffee. It may be difficult for a beginner to master all such techniques or know-hows.

In early times, when a person wants to enjoy a cup of coffee, the simplest way is to buy a pack of 3-in-1 coffee powder, pour it into a coffee cup, add some hot water and stir, and the coffee is ready to drink. Later, 3-in-1 coffee can no longer satisfy the need of consumers with higher requirements for flavor and taste. People started to grind coffee beans and brew coffee by themselves. Such pour-over coffee is commonly known as pour-over coffee. There are dozens of devices used to make pour over coffee, such as grinder, kettle, filter, thermometer, and electronic scale. It takes time and effort to get familiar with such devices only, not to mention the precise proportions and detailed steps. Therefore, many pour-over coffee beginners find it too complicated and may easily give up the idea of making coffee by themselves. Of course, there are still some people who buy coffee beans and a grinder to make pour-over coffee by themselves and enjoy the different flavor and taste.

It is certainly not easy to make a cup of “good coffee”. The most simple way is to simulate an ideal process of making pour-over coffee and try it over and over again. However, this requires a lot of time and effort, and may not be realistic for most modern people who are typically busy.

### SUMMARY OF THE INVENTION

The object of the present invention is to provide a pour-over coffee replication system, which uses an electronic device to obtain such data as the time sequence of the weight of coffee beans (powder) and the time sequence of water temperature during the process of making pour-over coffee, and integrates and converts the data into a digital coffee making prescription. The prescription can be uploaded to a cloud server for storage, so that one or more than one user can access from anywhere or at anytime. The digital coffee making prescription can be obtained simply by connecting the coffee machine to the cloud server, and the coffee machine can automatically replicate the processes of making pour-over coffee and prepare coffee having the same flavor and taste as pour-over coffee.

To accomplish the above object, the inventor of the present invention has designed a pour-over coffee replication system, which comprises: an electronic scale to obtain a time sequence of the weight of coffee beans (powder) and water during the process of making pour-over coffee; a thermometer to obtain a time sequence of the water temperature during the process of making pour-over coffee; a mobile device, with a built-in App to access the electronic scale and the thermometer to obtain the weight/temperature time sequences and integrate and convert the data into a digital coffee making prescription, and to upload the prescription to a cloud server; a cloud server, having a cloud database, for receiving and storing the digital coffee making prescription uploaded by the mobile device; and a coffee machine, to access the cloud server to download the digital coffee making prescription, and to automatically and dynamically adjust the water temperature / flow speed / flow volume to produce coffee having the same flavor and taste as pour-over coffee.

In one preferred embodiment, the electronic scale and the thermometer are both provided with a wireless transmission unit, and use Bluetooth for wireless data transmission.

In one preferred embodiment, the mobile device can be any of a mobile phone, a tablet computer, a notebook computer, a smart watch, an electronic bracelet, etc.

### BRIEF DESCRIPTION OF THE DRAWINGS

FIG. 1 is a schematic view of the pour-over coffee replication system according to a preferred embodiment of the present invention.

FIG. 2 is a flowchart of the pour-over coffee replication system according to a preferred embodiment of the present invention.

FIG. 3 is a schematic view of the pour-over coffee replication system according to another preferred embodiment of the present invention.

### DETAILED DESCRIPTION

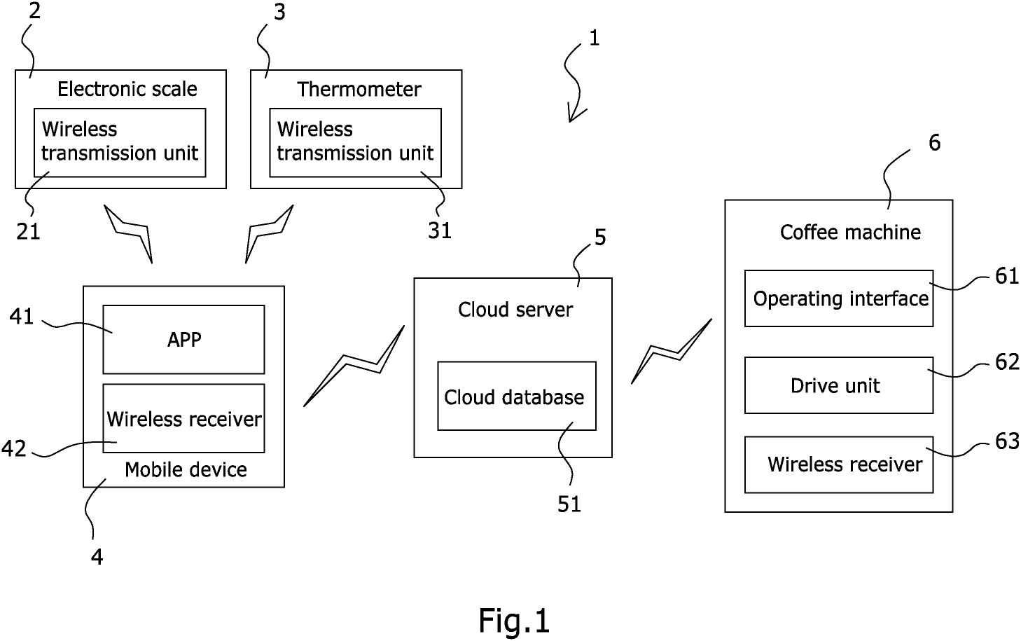

Referring to FIG. 1, which is a schematic view of the pour-over coffee replication system (1) according to a preferred embodiment of the present invention, the system comprises: an electronic scale (2), a thermometer (3), a mobile device (4), a cloud server (5) and a coffee machine (6). The electronic scale (2) is used to weigh the coffee beans (powder) to be used, as well as the hot water to be poured during the process of making pour-over coffee, so as to obtain the weight time sequence reflecting weight change during the process of making pour-over coffee; the electronic scale (2) is provided with a wireless transmission unit (21) to facilitate output of the obtained data of the weight time sequence. The thermometer (3) is used together with a kettle that pours hot water in a spiral form over the coffee powder on the filter screen of the filter cup during the process of making pour-over coffee, so as to obtain the water temperature time sequence reflecting change of the water temperature and water flow speed during the process of making pour-over coffee; the thermometer (3) is provided with a wireless transmission unit (31), to facilitate output of the obtained data of the water temperature time sequence. The mobile device (4) is installed with an App (41) and a wireless receiver (42). Through wireless transmission, the App can be operated to be connected to the electronic scale (2) and the thermometer (3), to obtain the weight/temperature time sequences, which are then integrated and converted into a digital coffee making prescription to be uploaded to a cloud server (5). The cloud server (5) is a network platform, having a cloud database (51); upon receiving the digital coffee making prescription uploaded by the mobile device (4), the cloud server (5) will store it in the cloud database (51). The coffee machine (6) provides a function for automatic coffee-making, and at least comprises: an operating interface (61), a drive unit (62) and a wireless receiver (63); through the operating interface (61), the wireless receiver (63) can be connected to the cloud server (5) to download the digital coffee making prescription stored in the cloud database (51), and the drive unit (61) can be actuated for automatic coffee-making with dynamic adjustment of the water temperature / flow speed / flow volume, simulating the process of making pour-over coffee and producing coffee having the same flavor and taste as pour-over coffee.

In the present embodiment, the wireless transmission unit (21) of the electronic scale (2) and the wireless transmission unit (31) of the thermometer (3) uses Bluetooth for wireless data transmission. However, this is not limited. Any of the common wireless transmission technologies including Zigbee, WiFi, UWB, or NFC can be used to realize wireless data transmission.

In the present embodiment, the mobile device (4) can be any of a mobile phone, a tablet computer, a notebook computer, a smart watch, or an electronic bracelet.

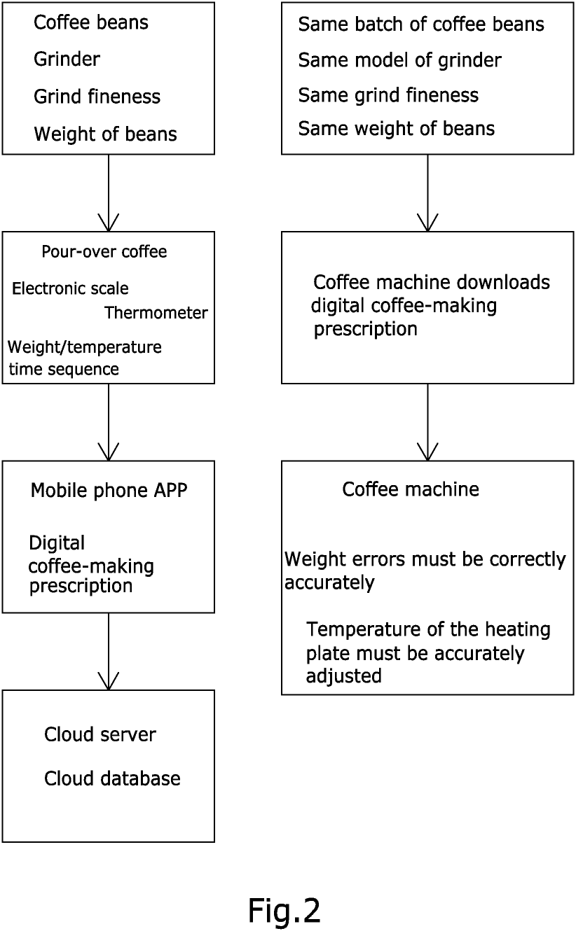

Further referring to FIG. 2, to obtain a digital coffee making prescription, firstly the kind of coffee beans, the grinder and the fineness of grind are determined. Then, the electronic scale (2) is used to weigh the coffee beans to be used, and the grinder is used to grind the beans into coffee powder. A holding container (e.g., coffee cup) is placed on the electronic scale (2). After confirmation of the proportion between coffee powder and water (typical proportions are 1: 10, 1: 15 or 1: 20), the filter cup is placed above the holding container. The filter cup is placed with a piece of filter paper. The ground coffee powder is poured into the filter cup. A kettle contained with hot water and combined with a thermometer (3) is used to pour hot water. The temperature of the hot water can be preset as needed (typically 85~95□). Then, hot water is slowly poured into the filter cup, till the weight displayed on the electronic scale (2) reaches the preset value. Now, a cup of pour-over coffee is ready to serve in the holding container. During the above process of making pour-over coffee, the electronic scale (2) is used to weigh the coffee beans (powder) and the water, and to record the value changes, and the thermometer (3) measures the temperatures from initial pouring till end of pouring and records the temperature changes over time. The App (41) of the mobile device (4) is operated to access the electronic scale (2) and the thermometer (3) to respectively obtain the data of weight time sequence and temperature time sequence, and to integrate and convert the data into a digital coffee making prescription with a complete record of the whole process of making pour-over coffee. The completed digital coffee making prescription is uploaded to the cloud server (5) and is stored in the cloud database (51).

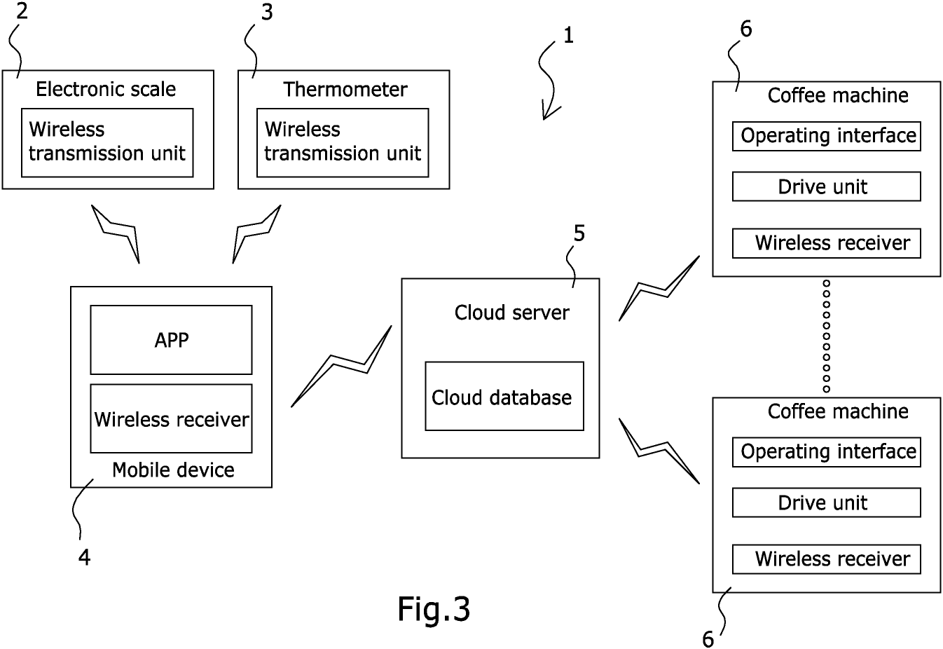

Referring collectively to FIG. 2 and FIG. 3, when replicating the process of making pour-over coffee, a coffee machine (6) with an automatic coffee-making function is used. One or more than one user can access the cloud server (5) through the operating interface (61) of the coffee machine (6) and download the digital coffee making prescription from the cloud database (51). As long as the same kind of coffee beans are prepared, the automatic coffee-making function of the coffee machine (6) can be used to replicate the process of making pour-over coffee and produce coffee having the same flavor and taste as pour-over coffee.

Further benefits and advantages of the present invention will become apparent after a careful reading of the detailed description with appropriate reference to the accompanying drawings.

1. A pour-over coffee replication system, comprising:
an electronic scale, for obtaining the weight time sequence of the coffee beans (powder) as well as the water during the process of making pour-over coffee;
a thermometer, for obtaining the temperature time sequence of the hot water during the process of making pour-over coffee;
a mobile device, having a built-in App to access the electronic scale and the thermometer to obtain the weight/temperature time sequences and integrate and convert them into a digital coffee making prescription, and upload it to a cloud server;
a cloud server, having a cloud database, used to receive the digital coffee making prescription uploaded by the mobile device and store it in the cloud database; and
a coffee machine, to access the cloud server to download the digital coffee making prescription, and to replicate the process of making pour-over coffee by automatically and dynamically adjusting the water temperature / flow speed / flow volume, and produce coffee having the same flavor and taste as pour-over coffee.

2. The pour-over coffee replication system defined in claim 1, wherein said electronic scale and thermometer have built-in wireless transmission unit, and use Bluetooth for wireless data transmission.

3. The pour-over coffee replication system defined in claim 1, wherein said mobile device can be any of mobile phone, tablet computer, notebook computer, smart watch, or electronic bracelet.
